(19) United States
(12) Patent Application Publication
(10) Pub. No.: US 2008/0233870 A1
(43) Pub. Date: Sep. 25, 2008

(54) Adapter and Method for Wireless Transfer of Memory Card Contents

(76) Inventor: Wolfgang Otto Budde, Aachen (DE)

Correspondence Address: PHILIPS INTELLECTUAL PROPERTY & STANDARDS, P.O. BOX 3001, BRIARCLIFF MANOR, NY, 10510, US

(21) Appl. No.: 10/573,745

(22) PCT Filed: Sep. 16, 2004
(86) PCT No.: PCT/IB04/51777

§ 371 Date: Mar. 28, 2006

(30) Foreign Application Priority Data
Sep. 29, 2003 (EP) 03103595.9

(51) Int. Cl. H04B 7/00

(52) U.S. Cl. 455/41.2

(57) ABSTRACT

The invention relates to an adapter (1) for wireless transfer of memory card contents, having a receptacle (2) for the contact piece (721) of a memory card (72) and a contact piece (3) that corresponds to that of the memory card (72), including a splitter (5) and also a transmitter (41) with series-connected antenna (42). The invention moreover relates to a method for the transfer of video and/or audio signals from portable devices (7) having a removable memory module (72) to playback equipment (9), wherein between the memory module (72) and the module slot (71) of the portable device (7) there is arranged an adapter'(1), which transfers the data flow between memory module (72) and portable device (7), without having an effect thereon, additionally wirelessly to a receiver (8) that is connected with the playback equipment (9).

The market for portable CE (Consumer Electronic) devices is expanding steadily. Serious growth spurts are to be noted in particular in the field of audio and video apparatuses. The field of digital photography is one example that can be mentioned here. Once simply the exclusive equipment of professional photographers, digital cameras have made an appearance at all levels of photography. There is hardly anyone who cannot call a digital camera his own. A key advantage of digital cameras is that no film is needed. The pictures are stored in the form of digital data on exchangeable memory cards. The stored data can subsequently be downloaded onto a computer for viewing or for further processing. Furthermore, it is possible to connect the camera by way of a special cable to a television set or a monitor and subsequently view the pictures there. This procedure proves very costly, since for one thing the cabling is often complicated, and for another the length of such a cable is limited, so that the camera and its user have to remain in the immediate vicinity of the monitor or television set.

US 2002/0174337 A1 discloses a memory card that in addition to the rewritable memory (flash RAM) comprises a communication unit with which data can be transferred wirelessly. Furthermore, on the card there is arranged a controller, via which direct access to the memory via the communication unit is rendered possible. To safeguard the data transfer, an encoding and decoding unit is provided between the memory and the communication unit. Because of the complex construction of the card, however, this proves cost-intensive, especially owing to the fact that is replaces existing conventional memory cards. If a high memory capacity is needed, several such cards may need to be kept on hand, which in turn has an adverse effect on costs.

The intention of the invention is to remedy this situation. It is an object of the invention to produce an adapter for wireless transfer of card contents that can be manufactured at reasonable cost and that allows continued use of conventional memory cards. In accordance with the invention that object is achieved by an adapter having a receptacle for the contact piece of a memory card and a contact piece that corresponds to that of the memory card, including a splitter, and also a transmitter unit comprising a transmitter with series-connected antenna.

With the invention, an adapter for wireless transfer of memory card contents is produced, which can be manufactured at reasonable cost and which allows continued use of conventional memory cards. This effect is achieved in particular owing to the fact that the adapter is arranged between the conventional memory card and the corresponding slot of the audio or video apparatus and the data flow between memory card and audio or video apparatus to the transmitter unit, comprising a transmitter with series-connected antenna, is copied. It is a further advantage of the invention that the user does not need to learn any new operating functions for transfer of the memory card contents to an output device.

The user rather uses the portable device operating functions with which he is familiar, and the data flow resulting therefrom is copied and transferred to the playback equipment.

In a further aspect of the invention, the adapter comprises a buffer memory. This enables times between two data flows, for example two images, to be buffered. As one image is being loaded, the previous image can continue to be transmitted from the buffer to the playback equipment (e.g. television set).

The transmitter preferably conforms to the Bluetooth standard. This wireless transmission standard allows low energy consumption and also ranges of up to ten meters. Furthermore, this standard allows the manufacture of transmitter and receiver units are reasonable cost. Transmitters conforming to the IEEE 802.11 (WLAN) or the ZigBee standard are a suitable alternative.

The receptacle for the adapter is advantageously in the form of a multicard slot for different types of memory card. This allows the use of several different memory cards with one and the same adapter.

In another aspect of the invention, the adapter comprises a controller, which is controllable by way of the contact piece and via which the transmitter unit can be switched on and off. This allows deactivation of the adapter when not in use, with the result that on the one hand power consumption is reduced and on the other hand it is possible to prevent an unwanted data transfer.

In one embodiment of the invention, the transmit channel of the transmitter unit is adjustable by means of the controller. This allows a channel change, for example, in the case of interference or noise effects.

It is a further object of the invention to produce a method for transmitting video and/or audio signals from portable devices having a removable memory module to playback equipment, which method can be realized at reasonable cost and with which the continued use of conventional memory cards is possible. In accordance with the invention the object is achieved in that between the memory module and the module slot of the portable device there is arranged an adapter, which transfers the data flow between memory module and portable device, without having an effect thereon, additionally wirelessly to a receiver that is connected with the play-back equipment.

The invention provides a method for the transfer of video and/or audio signals from portable devices having a removable memory module to playback equipment, which method can be realized at reasonable cost and with which the continued use of conventional memory cards is possible.

In one embodiment of the invention, the receiver is connected with the playback equipment in such a manner that on receiving data it is automatically switched to the operating state required for the playback. This allows a convenient playback of data without further operating steps being required at the playback equipment.

The receiver is advantageously automatically switched into a low-consumption mode when a transmit signal is absent for a defined period. This avoids unnecessary power consumption, which again has the effect of minimizing costs.

Other aspects and embodiments of the invention are specified in the remaining dependent claims. These and other aspects of the invention are apparent from and will be elucidated with reference to the embodiments described hereinafter.

In the drawings:

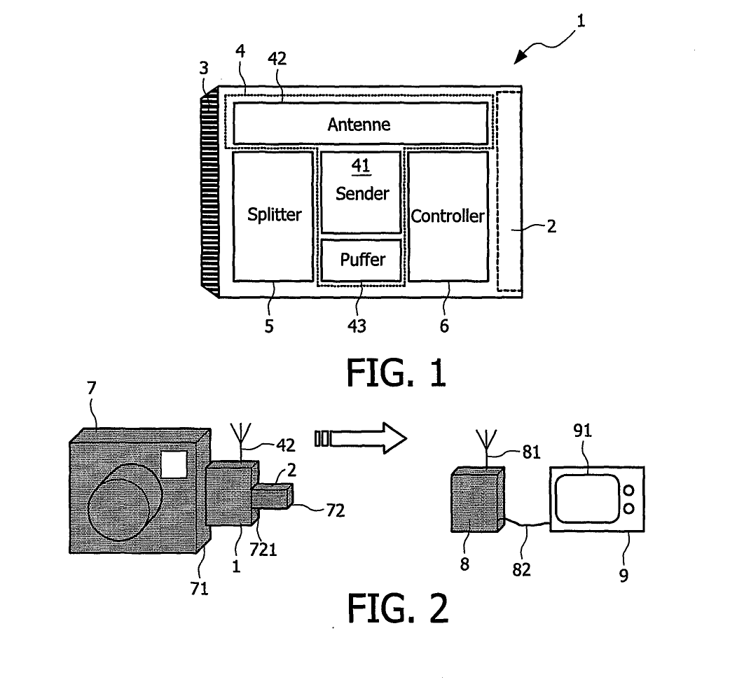

FIG. 1 shows the schematic representation of an adapter, and

FIG. 2 shows an example of the arrangement of a wireless transfer using an adapter.

The adapter 1 chosen as the exemplary embodiment is of substantially cuboidal construction. A slot 2 for a compact flash (CF) card is arranged on one transverse side of the adapter. On the opposite transverse side, the adapter has a contact piece 3 that is identical with the contact piece of the CF card.

A transmitter unit 4 comprising a transmitter 41 with series-connected antenna 42 arranged inside the adapter. For buffering image data, a buffer memory 43 is furthermore provided in the transmitter unit 4. The buffer memory is of such dimensions that it is able to hold two images of the camera 7 at maximum resolution. A splitter 5 is connected upstream of the transmitter unit 4. The function of the splitter is to duplicate the data flow and relay it to the transmitter unit 4. Upstream of the transmitter unit 4 there is also connected a controller 6. By means of the controller 6, the channel of the transmitter unit 4 can be varied and the transmitter unit 4 as such can be switched on and off. The controller is controlled by way of the contact piece 3.

In the exemplary embodiment in accordance with FIG. 2, the adapter 1 is inserted in the slot 71 of the digital camera 7. In the slot 2 of the adapter 1 there is a memory card (CF card) 72. If an image is loaded from the memory card 72 by way of the camera 7, then the data flow between memory card 72 and camera 7 is copied by the splitter 5 of the adapter 1 to the transmitter unit 4, which files the data in the buffer 43 and transmits it via the antenna 42. Apart from the audio and/or video data, the data flow can additionally contain so-called “meta-data”, such as recording time, resolution, interpret, etc.

The transmitted data is received through the antenna 81 of the receiver 8, which is set to the transmit channel of the transmitter unit 4. In the exemplary embodiment, transmitter and receiver conform to the Bluetooth standard. The transmit channel of the transmitter unit 4 is adjustable by means of an input device 9 (not illustrated) of the adapter. Agreement on the identity of transmitter and receiver is effected by way of the customary Bluetooth pairing procedure. The data packets received by the receiver are acknowledged by so-called “acknowledge messages to the transmitter, thus avoiding any loss of data.

The received data is passed from the receiver 8 via a SCART cable 82 to the television set 9, which reproduces the corresponding image on its screen 91. In the exemplary embodiment, the SCART plug is in the form of a “feed-through plug”, that is, the plug has a SCART socket on the opposite side of its housing, as a result of which the SCART slot of the television set can be used for the video recorder without cables having to be changed over.

Via the SCART connection of the television set, on receiving data the latter is automatically switched to audio/video (AV) mode and the transmitted images are displayed on the screen 91. The data of an image is transmitted from the transmitter unit 4 via the buffer 43 until a further data sequence is stored in the buffer 43. From the point onwards, the data of the new image is transmitted, and the memory area occupied by the preceding image is cleared for new storage.

Alternatively, the buffer 43 can be arranged in the receiver 8. In that case, the data flow existing between the memory card 72 and the slot 71 is transmitted exactly by the camera 7. The receiver 8 buffers the data appropriately in the buffer and relays it from there to the television set 9. If the receiver 8 receives no data, then the buffer content is continuously relayed to the television set 9 until the next data receipt. The receiver 8 can also be integrated in the television set 9.

### LIST OF REFERENCE NUMERALS

1 Adapter
2 Slot
3 Contact piece
4 Transmitter unit
5 Splitter
6 Controller
7 Digital camera
8 Receiver
9 Television set
41 Transmitter
42 Antenna
43 Buffer
71 Slot
72 Memory card
721 Contact piece
81 Antenna
82 SCART cable
91 Screen

1. An adapter (1) for wireless transfer of memory card contents, having a receptacle (2) for the contact piece (721) of a memory card (72) and a contact piece (3) that corresponds to that of the memory card (72), including a splitter (5) and also a transmitter unit (4) comprising a transmitter (41) with series-connected antenna (42).

2. An adapter as claimed in claim 1, characterized in that it comprises a buffer memory (43).

3. An adapter as claimed in claim 1, characterized in that the transmitter unit (4) conforms to the Bluetooth standard.

4. An adapter as claimed in claim 1, characterized in that the transmitter unit (4) conforms to the ZigBee standard.

5. An adapter as claimed in claim 1, characterized in that the transmitter unit (4) conforms to the IEEE 802.11 (WLAN) standard.

6. An adapter as claimed in claim 1, characterized in that the receptacle (2) is in the form of a multicard slot for different types of memory card.

7. An adapter as claimed in claim 1, characterized in that it comprises a controller (6), which is controllable by way of the contact piece (3) and via which the transmitter unit (4) can be switched on and off.

8. An adapter as claimed in claim 7, characterized in that the transmit channel of the transmitter unit (4) is adjustable by means of the controller (6).

9. A method for the transfer of video and/or audio signals from portable devices (7) having a removable memory module (72) to playback equipment (9), wherein between the memory module (72) and the module slot (71) of the portable device (7) there is arranged an adapter (1), which transfers the data flow between memory module (72) and portable device (7), without having an effect thereon, additionally wirelessly to a receiver (8) that is connected with the playback equipment (9).

10. A method as claimed in claim 9, characterized in that the portable device (7) is a digital photographic camera, the removable memory module (72) is a compact flash (CF) card and the playback equipment (9) is a television set.

11. A method as claimed in claim 9, characterized in that the portable device (7) is a digital audio apparatus, the removable memory card (72) is a compact flash (CF) card or secure digital (memory) SD card and the playback equipment (9) is an audio amplifier.

12. A method as claimed in claim 9, characterized in that the receiver (8) is connected with the playback equipment (9) in such a manner that on receiving data it is automatically switched to the operating state required for the playback.

13. A method as claimed in claim 9, characterized in that the receiver (8) is automatically switched into a low-consumption mode when a transmit signal is absent for a defined period.

14. A method as claimed in claim 9, characterized in that the data transfer is effected in accordance with the Bluetooth standard or the ZigBee standard or the IEEE 802.11 (WLAN) standard.
